(19) United States
(12) Patent Application Publication
(10) Pub. No.: US 2026/0106047 A1
(43) Pub. Date: Apr. 16, 2026

(54) CARBON NANOSTRUCTURE COMPOSITES FOR RADIATION SHIELDING AND METHODS OF MAKING AND USING THEREOF

(71) Applicant: CARBICE CORPORATION, Atlanta, GA (US)

(72) Inventors: Baratunde COLA, Atlanta, GA (US); Craig GREEN, Atlanta, GA (US); Erik ANDERSON, Atlanta, GA (US)

(21) Appl. No.: 19/116,362

(22) PCT Filed: Oct. 2, 2023
(86) PCT No.: PCT/US2023/075674

§ 371 Date: Mar. 28, 2025

Related U.S. Application Data
(60) Provisional application No. 63/377,927, filed on Sep. 30, 2022.

(51) Int. Cl. G21F 1/12; B32B 7/12; B32B 9/04; C01B 32/168

(52) U.S. Cl. CPC G21F 1/12; B32B 7/12; B32B 9/04; C01B 32/168; B32B 2255/205; B32B 2307/212; C01B 2202/08

(57) ABSTRACT

Carbon nanostructure-based composites and methods of making and using thereof are described. The carbon nanostructure-based composites may be single-layered or multi-tiered composites. Such composites can be useful for radiation shielding, such as experienced by spacecraft and space satellites.

### CROSS-REFERENCE TO RELATED APPLICATION

This application claims priority to and benefit of U.S. Provisional Application No. 63/377,927, filed Sep. 30, 2022, which is hereby incorporated herein by reference in its entirety.

### FIELD OF THE INVENTION

This invention is in the field of carbon nanostructure-containing composites and methods of making and using thereof.

### BACKGROUND OF THE INVENTION

Space electronic systems employ enclosures to shield sensitive components from space radiation that can destroy or cause malfunctions in spacecraft electronics. The purpose of shielding is to attenuate the energy and flux of ionizing radiation as they pass through the shield material, such that the energy per unit mass (or dose) absorbed is sufficiently below the maximum dose ratings of electronic components (Atxaga, G., et al., Radiation Shielding of Composite Space Enclosures. in International Astronautical Congress (IAC-12, C2.6.6,x13735). 2012. Naples, Italy).

The shielding effectiveness of any material depends on the type of incident radiation, ranges of energies, exposure time, and secondary radiation; and is thus indirectly dependent on space mission parameters (orbit, altitude, inclination and duration) and spacecraft design (spacecraft wall thickness and panel-enclosure location). Space radiation consists mainly of electrons and protons, solar particle events (SPEs), and galactic cosmic rays (GCR). Space missions may also encounter trapped radiation within the Van Allen belts. Galactic cosmic rays, for instance, due to their high kinetic energies and fragmentation tendencies, can be difficult to shield passively. As noted in Measuring Space Radiation Shielding Effectiveness by Amir Bahadori, et al., Old Dominion University, galactic cosmic rays consist of heavy charged particles (such as protons, neutrons, and alpha particles), ranging in atomic number from 1 (protons) to 58 (nickel ions) and above, with protons comprising about 90% and alphas comprising about 9% of the galactic cosmic ray spectrum (J. Simpson, Annu Rev Nucl Part S 33 323-382 (1983) Elemental and Isotopic Composition of the Galactic Cosmic Rays). The kinetic energies range from fractions of one megaelectron-volt per nucleon (MeV n⁻¹) to thousands of gigaelectron-volts per nucleon (GeV n⁻¹), although the vast majority of ions have kinetic energies less than 50 GeV n⁻¹. The flux density spectra for galactic cosmic ray ions peak at kinetic energies between 100 MeV n⁻¹ and 1 GeV n⁻¹. Solar particle events are a concern for human space flight in the low cutoff rigidity regions of low-Earth orbit (e.g., near the geomagnetic poles) and outside of low Earth orbit, such as missions to the Moon or Mars. Such major solar particle events have spectral characteristics that can vary.

It is known that low-Z materials can attenuate protons better than their high-Z counterparts, whereas high-Z materials can attenuate electrons and photons (e.g. x- and γ-rays) more effectively. For space electronics, both protons and electrons should be attenuated so bilayer (a high-Z layer on the outside and a low-Z layer on the inside) or trilayer (low-Z-high-Z-low-Z) concepts have been pursued for enhanced shielding performance (Condruz, M. R., et al., Fiber Reinforced Composite Materials for Proton Radiation Shielding. Materiale Plastice, 2018. 55(1): p. 5-8). On a mass basis, low Z materials like hydrogen can be more effective at shielding per unit mass than their higher Z counterparts because of their relatively high electron to nucleon ratio.

Low-Z polymer matrix materials with high hydrogen content can be reinforced with micro- or nanoscale fibers (e.g. carbon microfiber or carbon nanotubes) resulting in much higher specific strength (strength per unit weight versus Al), stiffness, corrosion and fatigue resistance, tailorable electrical and thermal conductivity, controlled thermal expansion and the ability to be processed into complex shapes. However, conventional graphite epoxy composites are not as efficient radiation shielding materials as aluminum (providing 30 to 40% less radiation attenuation) (Abusafieh, A., et al., The development of lightweight radiation shielding composite for electronic enclosures. in 44th International SAMPE Symposium).

In the past two decades, several studies have shown that nanomaterial fillers in composites can impart an enhanced ability to absorb photons due to their large surface-area-to-volume ratio (Xu, C., et al., Chem. Mater., 2008. 20: p. 4167-4169). High-Z metal nanoparticles have also been investigated as fillers in polymer nanocomposites. Tantalum is common due to its low toxicity versus lead and has achieved ≥25% weight savings over aluminum in electron dominated environments such as GPS and Geosynchronous orbits. Similar results were achieved with tungsten which is significant for a multifunctional composite because tungsten has almost three times the thermal conductivity of tantalum (Abusafieh, A., et al., The development of lightweight radiation shielding composite for electronic enclosures. in 44th International SAMPE Symposium). Recently both CNTs and tungsten nanoparticles were incorporated into polymer composite structures at relatively high loadings in an attempt to optimize the performance of multifunctional radiation shields and resulted in a higher decrease in the protons energy detected behind the lighter weight and thinner composite shield versus the reference aluminum shield (Atxaga, G., et al., Radiation Shielding of Composite Space Enclosures. in International Astronautical Congress (IAC-12, C2.6.6,x13735). 2012. Naples, Italy).

Nevertheless, significant challenges remain for providing radiation shielding materials and their fabrication and scalable manufacturing of such high-performance radiation shielding materials. These include: (1) the ability to form optimal and stable dispersion of nanofillers into the resin so that the mixture can be stable across time without any re-agglomeration effect; (2) the ability to increase the loading of nanofillers without significantly increasing the viscosity of polymer resins, which makes the dispersion and resin flow extremely difficult leading to defective laminates; (3) the ability to uniformly disperse nanofillers into the polymer matrix resulting in homogeneous shielding properties throughout the composite; and (4) the ability to obtain a high degree of alignment of nanostructures with high electrical and thermal conductivity within the composite to enable additional multifunctional property enhancement such as efficient thermal cycling, heat transfer, mitigation of spacecraft charging, and/or electro-magnetic interference (EMI) shielding.

Furthermore, when the end use of such radiation shielding materials has structural requirements, such as for spacecraft panels, the strength, vibration tolerance and other mechanical properties of the shielding material become equally as important as the shielding effectiveness.

Thus, there is a need for radiation shielding materials that can address the issues mentioned above and methods of making such materials.

Therefore, it is an object of the invention to provide radiation shielding materials with improved properties and performance over the current state of the art radiation shielding materials.

It is a further object of the invention to provide methods of making and using such radiation shielding materials.

### SUMMARY OF THE INVENTION

Carbon nanostructure-based composites containing low-Z and high shielding efficiency (such as high-Z) materials and having radiation shielding properties are described herein. A non-limiting exemplary composite is shown in FIG. 1.

The carbon nanostructure-based composites described herein can optionally contain a high shielding efficiency coating on the vertically aligned carbon nanostructures. The high shielding efficiency material can form a coating which can be made of elements, molecules, polymers, or other such materials which have a high Z value to provide a high shielding effectiveness per thickness, or can have low Z value, like hydrogen or boron, which provide high shielding effectiveness per mass.

The high shielding efficiency material coating can be deposited onto the plurality of vertically aligned carbon nanostructures (i.e., carbon nanotubes) forming the arrays to yield an optionally conformal metal coating on the carbon nanostructures (i.e., carbon nanotubes) using various techniques described, such as ALD, CVD, MOD, etc.

The high shielding efficiency material coating, when present on the vertically aligned carbon nanostructures, can further be encapsulated by a low-Z material, such as a polymer coating. The low-Z material encapsulant coats the high shielding efficiency material coated array of carbon nanostructures. In preferred instances, the low-Z material fully encapsulates the carbon nanostructure-based composites. In some other instances, only a low-Z material is present on the vertically aligned carbon nanostructures of the composites without a high shielding efficiency material coating present.

Various methods of forming single-layered and multi-layered carbon nanostructure-based composites are described below.

The single-layered and multi-tiered carbon nanostructure-based composites described herein can be used in various applications, such as radiation shielding applications.

### BRIEF DESCRIPTION OF THE DRAWINGS

FIG. 1A shows a non-limiting representation of a single-layered carbon nanostructure-based composite (100) including a substrate or support (110) on which a vertically aligned carbon nanostructures (i.e., carbon nanotubes) (120) are present and where the vertically aligned carbon nanostructures have an optional high shielding efficiency material conformal coating (130) thereon and a low-Z material coating (140) on the composite, as shown.

FIG. 1B shows a non-limiting representation of a multi-tiered carbon nanostructure-based composite formed from a stack of three single-layered carbon nanostructure-based composites and providing a three-tiered carbon nanostructure-based composite (200).

FIG. 2A shows a non-limiting representation of a method of making a carbon nanostructure-based composite including the steps of providing a vertically aligned carbon nanostructures on a substrate; coating the vertically aligned carbon nanostructures with high shielding efficiency material via atomic layer deposition (ALD); and applying a low-Z material encapsulant thereon to afford a nanostructure-based composite.

FIG. 2B shows a non-limiting representation of a method of making a multi-tiered carbon nanostructure-based composite wherein three single-layered nanostructure-based composites are stacked to form a three-tiered nanostructure-based composite.

FIG. 3 shows a graph of total ionizing dose as a function of thickness of a carbon nanostructure-based composite (CNT/Bismuth/Polyethylene) exposed to a Cobalt-60 source.

### DETAILED DESCRIPTION OF THE INVENTION

Carbon nanostructure-based composites containing low-Z and high shielding efficiency (such as high-Z) materials and having radiation shielding properties are described herein.

### I. Definitions

“Substrate” or “support”, as used herein, refers to the material on which the nanotubes are grown. A variety of materials can serve as a support. Generally, the support is inert, meaning that the support does not chemically participate in the formation of nanotubes on the multilayer substrate. In some embodiment, the support is formed at least in part from a metal including, but not limited to, aluminum, cobalt, chromium, zinc, tantalum, platinum, gold, nickel, iron, tin, lead, silver, titanium, indium, copper, or combinations thereof and/or one or more metal oxides, such as oxides of the metals listed above.

“Conformal,” or “Conformally Coated,” as used herein means covering a surface topography of an object such that it is completely or effectively covered and the covered surface is free or substantially free of pin holes or other defects which expose the underlying material of the object.

“Carbon Nanotube Array” or “CNT array” or “CNT forest”, as used herein, refers to a plurality of carbon nanotubes which are vertically aligned on a surface of a material, such as a substrate or support. Carbon nanotubes are said to be “vertically aligned” when they are substantially perpendicular to the surface on which they are supported or attached. Nanotubes are said to be substantially perpendicular when they are oriented on average within 30, 25, 20, 15, 10, or 5 degrees of the surface normal.

“Low-Z material” as used herein, generally refers to elements, molecules, polymers, or other such materials having an atomic number (Z) below 8.

“High-Z material” as used herein, generally refers to elements, molecules, polymers, or other such materials having an atomic number (Z) of 8 or higher, or 12 or higher.

“High shielding efficiency” as used herein, generally refers to elements, molecules, polymers, or other such materials which have a high Z value to provide a high shielding effectiveness per thickness, or can have low Z value, like hydrogen or boron, which can provide high shielding effectiveness per mass.

“Polymer coating” as used herein, generally refers to polymers or molecules that bond to CNTs through van der Waals bonds, π-π stacking, mechanical wrapping and/or covalent bonds and bond to metal, metal oxide, or semiconductor material surfaces through van der Waals bonds, π-π stacking, and/or covalent bonds.

“Coefficient of Thermal Expansion,” as used herein, refers to a measure of a change in size, such as volume, per degree of change in temperature at a constant pressure.

“Electrical Conductivity,” or “Specific Conductivity,” as used herein, refer to the degree that a material can conduct an electric current, as is calculated as the ratio of the current density in the material to the electric field that causes the flow of current. It is the reciprocal of electrical resistivity. Electrical conductivity is typically reported in the SI units of Siemens per meter (S/m).

“Thermal contact resistance,” as used herein, refers to when two surfaces are in thermal contact and resistance to heat transfer between the surfaces exists.

“Thermal conductivity,” as used herein, refers to the transport of energy in the form of heat through a body of mass as the result of a temperature gradient and is determined as the heat energy transferred per unit of time and per unit of surface area divided by the temperature gradient. Thermal conductivity is typically expressed in units of W m⁻¹ K⁻¹.

“Thermal transmittance,” as used herein, refers to the rate of transfer of heat through matter. Thermal transmittance is typically expressed in units of W m⁻² K⁻¹.

“Tensile modulus,” alternatively known as Young's modulus or the modulus of elasticity, as used herein, refers to a measure of the stiffness of a material and is a measure of the ratio of stress along an axis to the strain along the same axis. Tensile modulus can be used to describe the elastic properties of a material or object when stretched or compressed.

“Conformable,” “Deformable,” or “Compliant,” are used interchangeably herein, and refer to the ability to conform or deform when a composite as described herein is contacted, typically under an applied pressure (i.e., compression force), to one or more surfaces. Conformance to the asperities, curvature, and/or nonplanarity of the adjoining surface(s) results in sufficient or high contact areas at the interfaces between the surfaces.

“Flexible,” as used herein, refers to the ability to deform/conform in response to an applied force, strain, or stress.

Numerical ranges disclosed in the present application include, but are not limited to, ranges of temperatures, ranges of pressures, ranges of weights, ranges of ratios, ranges of integers, ranges of conductance and resistance values, ranges of times, and ranges of thicknesses, etc. The disclosed ranges of any type, disclose individually each possible number that such a range could reasonably encompass, as well as any sub-ranges and combinations of sub-ranges encompassed therein. For example, disclosure of a thickness range is intended to disclose individually every possible thickness value that such a range could encompass, consistent with the disclosure herein.

Use of the term “about” is intended to describe values either above or below the stated value, which the term “about” modifies, in a range of approx. +/−10%; in other instances the values may range in value either above or below the stated value in a range of approx. +/−5%. When the term “about” is used before a range of numbers (i.e., about 1-5) or before a series of numbers (i.e., about 1, 2, 3, 4, etc.) it is intended to modify both ends of the range of numbers or each of the numbers in the series, unless specified otherwise.

### II. Carbon Nanostructure-Based Composites

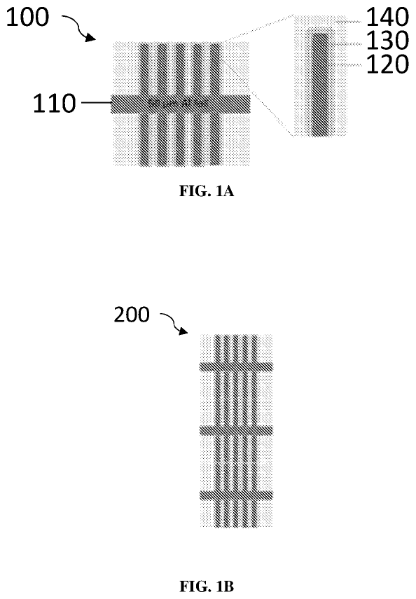

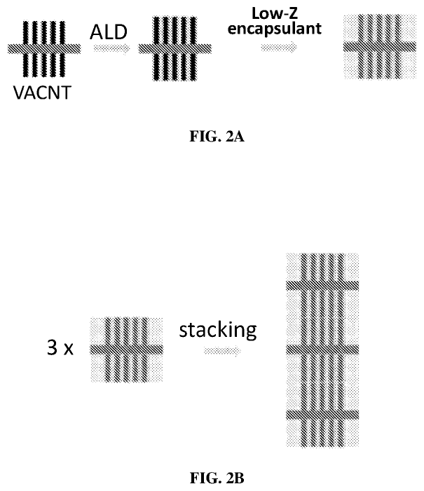

Carbon nanostructure-based composites are described herein. As shown in FIG. 1, the nanostructure-based composites (100) include a substrate or support (110) on which vertically aligned carbon nanostructures (i.e., carbon nanotubes) (120) are present and the vertically aligned carbon nanostructures have an optional high shielding efficiency material conformal coating (130) thereon and a low-Z material (140) coating on the composite, as shown. In some instances, the carbon nanostructure-based composites will include a low-Z material/high-Z material/low-Z material tri-layered motif. Details of the arrays of such vertically aligned carbon nanostructures are described below.

### A. Substrates/Supports for Vertically Aligned Carbon Nanostructures

A variety of materials can serve as a support or substrate for vertically aligned arrays of tubular shaped nanocarbon (i.e., carbon nanotube) materials. In some instances, the substrate or support is formed at least in part from a metal, such as, but not limited to, aluminum, cobalt, chromium, zinc, tantalum, platinum, gold, nickel, iron, tin, lead, silver, titanium, indium, copper, or combinations thereof and/or one or more metal oxides, such as oxides of the metals listed above. In other instances, materials can be, but are not limited to, ceramics and silicon or silicon compounds, such as silicon dioxide. In still other instances, the substrate or support is a metallic foil, such, but not limited to, aluminum foil or copper foil. In some instances, the substrate or support is made of aluminum. The substrate or support may have any suitable thickness. In some instances, the thickness is a range of 10 to 100 microns, 25 to 50 microns, or about 50 microns. In some instances, the support or substrate used to form carbon nanotubes (CNT) arrays thereon may be minimized by selecting the thinnest possible thickness that allows for formation of a vertically aligned array of carbon nanostructures, such as carbon nanotubes (CNT) thereon. In some instances, the substrate or support is an aluminum foil. Any suitable shape of substrate or support having any suitable dimension (i.e., length, width) may be used, but square or rectangular shapes are preferred. The substrate or support is typically a planar substrate or support. In some instances, the substrate or support can also provide tear strength, and malleability which are relevant in their ability to be formed into larger structures.

In some instances, the surface of the support may be treated to increase adhesion of the carbon nanostructures to be formed via the inclusion of a suitable adhesion layer or surface treatment, which may include the use of plasma-assisted or chemical-based surface cleaning. Other treatments can include the deposition of a metal or metal oxide coating or particles on the support.

The substrate or support, and conditions under which a vertically aligned array of carbon nanostructures, such as carbon nanotubes (CNT), are formed, can be selected such that the support resists reacting with the catalyst, process gases, and/or residual gases through reactions, such as oxidation, silicidation, alloying, and/or carbide formation. For example, C, O, H, and N are the elements composing most CNT CVD process and contamination gases. Reaction conditions, such as temperature, can be selected in order to minimize adverse reactions of the support.

### B. Vertically Aligned Carbon Nanostructures Arrays on Substrates/Supports or Vertically Aligned Carbon Nanostructure Sheets

In certain instances, the carbon nanostructures form tubular structures (i.e., carbon nanotubes) which form vertically aligned forests or arrays. Carbon nanotubes (CNTs) represent a versatile and lightweight material applicable to both structural and radiation shielding roles. For instance, aligned CNT arrays exhibit exceptional electrical, thermal conductivity, and mechanical strength. These CNT arrays can be tailored through methods like doping and encapsulation to provide multifunctional materials particularly suitable for various terrestrial and space-related applications. In particular instances, the vertically aligned carbon nanostructures are single, double, triple, or higher order multi-walled carbon nanotubes with diameters in the range from 10 to 40 nm, more preferably 15 to 30 nm, most preferably about 20 nm or less. The length of such carbon nanostructures can range from 0.01 to 5,000 microns, 0.1 to 2500 microns, 0.1 to 2000 microns, or 0.1 to 1000 microns, as well as sub-ranges or values within the aforementioned. In some instances, the length of such carbon nanostructures can range from about 10 microns to about 600 microns, about 10 microns to about 300 microns, or about 10 microns to about 100 microns, as well as any sub-ranges or values contained within.

In other instances, the carbon nanostructures can include, but are not limited to, fibers, wires, horns, cones, or other tube-shaped structures which have a high aspect ratio (i.e., greater than 1). The length of such other carbon nanostructures can range from 0.01 to 5,000 microns, 0.1 to 2500 microns, 0.1 to 2000 microns, or 0.1 to 1000 microns.

In certain instances, the vertically aligned carbon nanostructure arrays contain a plurality of carbon nanotubes which are vertically aligned on at least one surface of a metal or metal containing support or substrate. In some cases, the vertically aligned carbon nanostructure arrays contain a plurality of carbon nanotubes which are vertically aligned on both surfaces of a planar metal or metal containing support or substrate, such as those described above.

Although the vertically aligned carbon nanostructure arrays are typically grown on a metal or metal containing support or substrate, in some other instances a support or substrate is not required to be present. In some instances, carbon nanostructured sheets can be used in place of the vertically aligned carbon nanostructure arrays on a substrate or support. The sheets contain a plurality of carbon nanostructures that support each other through strong van der Waals force interactions, mechanical entanglement or polymer or other secondary material encapsulation to form a freestanding material. Methods of forming carbon nanostructure sheets is known in the art. The carbon nanostructures of the sheet can be carbon nanotubes and these can be aligned in plane where the carbon nanotubes are said to be “aligned in plane” when they are substantially parallel to a surface of the CNT sheet that they form. Carbon nanotubes are said to be substantially parallel when they are oriented on average greater than 40, 50, 60, 70, 80, or 85 degrees from sheet surface normal. It is understood that the vertically aligned carbon nanostructure arrays on a substrate or support can be substituted with such freestanding CNT sheets, which do not include any substrate or support present, to form radiation shielding composites having an optional high-Z material and a low-Z material thereon, as otherwise described herein.

In certain instances, the carbon nanostructure arrays are grown on the substrates described via chemical vapor deposition. Other methods of growing vertically aligned carbon nanostructure arrays are known in the art. Generally, the nanotubes are present at a sufficient density such that the nanotubes are self-supporting and adopt a substantially perpendicular orientation to the surface of the substrate or support. In some instances, the nanotubes forming the array are oriented, on average, within 30, 25, 20, 15, 10, or 5 degrees of the surface normal of a line drawn perpendicular to the surface of the substrate or support. Preferably, the nanotubes are spaced at optimal distances from one another and are of uniform height.

In certain instances, the carbon nanostructure are carbon nanotubes with a density on the support or substrate surface that ranges from about 1×10⁷ to 1×10¹¹ nanotubes per mm², more preferably from about 1×10⁸ to 1×10¹⁰ nanotubes per mm², most preferably from about 1×10⁹ to 1×10¹⁰ nanotubes per mm.

The carbon nanostructures of the arrays grown on substrates, or carbon nanostructure forming sheets, can contain defect sites thereon. For example, when the carbon nanostructures are carbon nanotubes the carbon nanotubes can contain defects, such as vacancies, interstitials, and most commonly bond rotations and non-hexagonal rings (e.g. 5-C pentagon defects). In some cases, they may contain hydrogen defects which can increase shielding efficiency of the carbon matrix of the arrays.

The carbon nanostructures of the arrays or sheets described above are considered a low-Z material.

### C. High Shielding Efficiency Coating on Vertically Aligned Carbon Nanostructures Forming Arrays

As noted above, the carbon nanostructure-based composites described herein can optionally contain a high shielding efficiency coating on the vertically aligned carbon nanostructures. The high shielding efficiency material can form a coating which can be made of elements, molecules, polymers, or other such materials which have a high Z value to provide a high shielding effectiveness per thickness, or can have low Z value, like hydrogen or boron, which provide high shielding effectiveness per mass.

In some instances, following the formation of the vertically aligned carbon nanostructures, a high shielding efficiency material coating is applied to the carbon nanostructures. In certain instances, the high efficiency shielding material is preferably a high Z material. In other instances, the high efficiency shielding material has a high electron to nucleon ratio, or is a bulk material, such as a hydrogen rich polymer, as described below. The high shielding efficiency material coating is preferably a conformal coating, such as a nanoscale coating. The nanoscale coating may have a thickness in a range from about 1-1,000 nm, about 1-500, or about 1-100 nm. In other instances, the high shielding efficiency material coating may be a conformal coating, such as a microscale coating. The microscale coating may have a thickness in a range from about 1-1,000 micrometer, about 1-100, or about 1-10 μm. The high shielding efficiency material coating, which may be a conformal coating, can cover all, substantially all, or partially the surfaces of the carbon nanostructures. “Substantially all,” as used herein, refers to less than about 5%, 4%, 3%, 2%, or 1% of the surface area of the carbon nanostructures is not coated by the high shielding efficiency material coating. “Partially,” as used herein, refers to less than complete coverage of the surfaces of the carbon nanostructures by the high shielding efficiency material coating, such as in a range of about 0.1 to about 99.9%, as well as sub-ranges or individual values contained within. Methods of evaluating and determining the extent of surface coverage of the carbon nanostructures by a coating are known in the art.

The high shielding efficiency material coating can be formed of, but is not limited to, a metal, metal alloy, and/or a metal oxide. In some instances, the metal can be, but is not limited to, aluminum, bismuth, cobalt, chromium, zinc, gallium, tantalum, platinum, gold, nickel, iron, tin, lead, silver, tungsten, titanium, indium, copper, antimony, zirconium, titanium, lithium, palladium or combinations or alloys thereof and/or one or more metal oxides, such as oxides of the metals listed above or metal hydrides such as hydrides of the metals above. In some instances, the metal selected can be bismuth (Bi) which has a mass attenuation comparable to that of lead. In some instances, the conformal coating is not a continuous film, but instead a dense decoration of individual nanoparticles along the length of the carbon nanotube from tip to root. In some instances, the high shielding efficiency material coating need not be a conformal coating but instead may exist only at or near the tips of the array. In some other instances the high shielding efficiency material may be dispersed throughout the thickness of the array, without forming a continuous film. In some instances, the high shielding efficiency material coating can be formed of one or more high-Z materials selected to provide a higher/greater shielding efficiency than an otherwise equivalent coating formed of aluminum, lead, tin, bismuth, or tungsten evaluated under the same conditions.

In certain instances, the low-Z carbon nanostructures (i.e., carbon nanotubes) are conformally coated by a high shielding efficiency material at the sidewalls of the CNTs and optionally at the tips of the carbon nanostructures (i.e., carbon nanotubes) or vice versa. In certain other instances, the carbon nanostructures (i.e., carbon nanotubes) are conformally coated by the high shielding efficiency material at both the sidewalls of the carbon nanostructures (i.e., carbon nanotubes) and at the tips of the carbon nanostructures (i.e., carbon nanotubes). In some instances, bundles of CNTs may be conformally coated by the high shielding efficiency material around one or more surfaces of such bundles, as may be present.

In certain instances, at least about 100%, 99%, 98%, 97%, 96%, 95%, 90%, 80%, 70%, 60%, 50%, 40%, 30%, 20%, or 10% of the low-Z carbon nanostructures (i.e., carbon nanotubes) surface is coated by the high shielding efficiency material coating. In certain non-limiting instances, the thicknesses of the high shielding efficiency material coating, such as nanoscale conformal coating, can range from about 0.1 to 50,000 nanometers, 500 to 50,000 nanometers, 1 to 10,000 nanometers, 5 to 5,000 nanometers, 5 to 1,000 nanometers, 5 to 500 nanometers, 5 to 250 nanometers, 0.1 to 1,000 nanometers, 1 to 500 nanometers, 5 to 250 nanometers, more preferably 5 to 100 nanometers, 5 to 50 nanometers, or 5 to 25 nanometers.

i. Deposition Methods for High Shielding Efficiency Material Coatings

The high shielding efficiency material coating can be deposited onto the plurality of vertically aligned carbon nanostructures (i.e., carbon nanotubes) forming the arrays or sheets to yield an optionally conformal metal coating on the carbon nanostructures (i.e., carbon nanotubes).

In some instances, one or more coatings of a high shielding efficiency material can be applied using atomic layer deposition (ALD) to form such coating(s). In some other instances, one or more coatings of the high shielding efficiency material can be vapor deposited onto the plurality of vertically aligned carbon nanostructures (i.e., carbon nanotubes), such as, via chemical vapor deposition (CVD) to form such coating(s). In still other instances, one or more coatings of the high shielding efficiency material can be vapor deposited onto the plurality of vertically aligned carbon nanostructures (i.e., carbon nanotubes), such as, via sputtering in order to form such coating(s).

ALD, however, is preferred in certain instances and can be used to deposit the desired high shielding efficiency material coating with high conformity and precise control of the thickness. The deposition is controlled at the atomic level by self-limiting surface reactions. Consequently, uniform and conformal deposition will occur on high aspect ratio porous structures because of self-passivating of the surface chemistry. Once the reaction is completed at one surface site, the reactants will continue to travel down the high aspect ratio pore and reach unreacted surface sites.

Methods of ALD, CVD, and sputter coating metal-based coatings and the reaction conditions and equipment needed to achieve such metal-based coatings are well-known in the art. The selection of appropriate metal precursors for formation of desired metal-based coatings made of, but not limited to, aluminum, bismuth, cobalt, chromium, zinc, gallium, tantalum, platinum, gold, nickel, iron, tin, lead, silver, tungsten, titanium, indium, copper, antimony, zirconium, titanium, lithium, palladium, or alloys/combinations are also known.

In some instances, the high shielding efficiency material coating can be multi-layer coating, where, for example, each layer may perform more than one function, such that there are two or more of the aforementioned high shielding efficiency material layers.

In certain non-limiting examples, the surface of the plurality of vertically aligned carbon nanostructures (i.e., carbon nanotubes) are coated via ALD with a tungsten (W) coating. The tungsten conformal coating may have any suitable thickness but may be, in some instances, in a range of between about 1 to 300 nm, 1 to 200 nm, 1 to 100 nm, 5 to 100 nm, 5 to 75 nm, or 5 to 50 nm, as well as sub-ranges or individual values contained within these ranges. In some instances, the coating is a 20 nm thick coating. A common limitation in metal deposition using ALD is the availability of reducing agents that can adsorb and react exothermically with surface-adsorbed metal precursors allowing ALD to proceed at temperatures <350° C. Of all ALD metal deposition processes, ALD tungsten (W) is a thermodynamically favorable process that uses, for example, tungsten hexafluoride (WF₆) and silane (SiH₄) or disilane (Si₂H₆) as reactants. An advantage of using W, which is a high-Z material, as the metal coating in some instances is that its high atomic number makes the resultant composite effective at preventing transmission of radiation. This is especially valuable for applications such as protection of electronics that must operate in environments such as space, where cosmic radiation bombardment is common.

In certain other instances, the one or more coatings of a high shielding efficiency material (high Z-material) can be applied using a wet coating method, such as metal organic deposition (MOD) ink methods (see for instance, Choi, et al., Adv. Mater. Interfaces, 2019, 6, 1901002). In such methods, the surface of the plurality of vertically aligned carbon nanostructures (i.e., carbon nanotubes) is infiltrated with a liquid phase containing metal precursors which can be thermally decomposed (i.e., by heating, UV, IR exposure) thereby forming and depositing metal, and/or metal oxides thereof, on the surface of carbon nanostructures (i.e., carbon nanotubes), particularly at any defect sites present which promote metal formation/deposition from the precursors. The decomposition of the metal precursors and formation of the metal-based coating therefrom is usually achieved by submerging the carbon nanostructures (i.e., carbon nanotubes) into an appropriate solvent (such as xylenes or limonene) containing the metal precursor(s) dissolved therein and applying heat, under an inert environment, to thermally decompose the metal precursor(s) and form the coating. Exemplary precursors include, but are not limited to, metal isopropoxides, metal hydrides (such as, without limitation, titanium hydride, AlH₃{O(C₄H₉)₂, AlH₃{N(CH₃)₃}), galistan, and metal salts. Metal salts can include, without limitation, silver nitrate, silver neodecanoate, silver oxalate, silver acetate, silver tartarate, silver hexafluoroacetylacetonate cyclooctadiene, bismuth 2-ethylhexanoate (bismuth Octoate), and bismuth nitrate Bi(NO₃)₃, tetraethyldibismuthine, boric acid (hydrogen borate), tungsten hexacarbonyl, copper acetate, copper formate tetrahydrate, copper formate, copper glycolate, copper lactate, copper oleate, copper hydroxide, nickel sulfate, nickel formate dihydrate, and nickel acetate. In some cases, the metal precursors are silver salts. In some other cases, the metal precursors are bismuth salts. Suitable conditions and parameters (solvents, concentrations, temperatures, heating times, etc.) used with MOD inks are known. In some instances, the MOD inks (such as metal salts) can have a concentration of about 5 to about 50% wt/wt of a suitable solvent. In some instances, bismuth 2-ethylhexanoate (C₂₄H₄₅BiO₆, BiEH) is used as precursor salt ink for an MOD process to deposit bismuth (such as Bi₂O₃) onto the surface of carbon nanostructures (i.e., carbon nanotubes). Suitable precursors and metal salts can be mixed with a solvent(s) to form an MOD ink solution, where solvent(s) and precursors/metal salts concentration can be used control the liquid rheology and control the coating uniformity on the onto the surface of carbon nanostructures (i.e., carbon nanotubes). After coating the CNTs with the MOD ink solution, carbon nanostructures (i.e., carbon nanotubes) can be heated to at least about 150° C., 175° C., 200° C., 225° C., or 250° C. for at least about 30 minutes, or longer, under a vacuum, which causes the precursors/metal salts present to decompose into metal, or oxides thereof, and coat the surfaces of carbon nanostructures (i.e., carbon nanotubes). In some instances high energy photons, for example UV light, may be included with or substituted for heating to drive the MOD decomposition process. In some instances, a binder may be added to the MOD inks to modify the rheology (viscosity) of the mixture and aid in depositing the ink due to the viscosity and flow characteristics. In certain stances, a CNT array may first be wetted with a solvent to pre-clump it (i.e., induce clumping of the CNTs present) and the solvent evaporated or dried, and then followed by application of the MOD ink to the clumped CNT array to access more surface area than would otherwise be accessible via direct liquid coating without pre-clumping. In some instances, when using an MOD ink, the CNTs may be first coated with a suitable polymer, such as those named elsewhere herein, to promote or improve uniformity and/or conformality of the coating formed using an MOD process.

In still other instances, the one or more coatings of a high shielding efficiency material can be applied using deposition via nanoparticle inks, which are dissolved in a suitable solvent, such as organic, aliphatic, or aromatic solvents, and then the solvent evaporated. As may be appropriate, additives or excipients, such as surfactants, may be added to the solvent(s) to promote dispersion of the nanoparticles therein. Non-limiting nanoparticles can be metal containing nanoparticles, metal oxide nanoparticles, or combinations thereof known in the art. Such nanoparticles can be Ag, Cu, Ni, W, Bi type nanoparticles. The nanoparticles can have any suitable dimensions or shape, and can be obtained from commercial sources or synthesized according to art known methods. In some cases, the nanoparticle inks are silver nanoparticle inks. In certain stances, a CNT array may first be wetted with a solvent to pre-clump it (i.e., induce clumping of the CNTs present) and the solvent evaporated or dried, and then followed by application of the nanoparticle ink to the clumped CNT array to access more surface area than would otherwise be accessible via direct liquid coating without pre-clumping.

In some instances, the high shielding efficiency material coatings are preferably made of silver or have a high silver content (such as, at least about 10 to about 99% or about 50 to 99% silver by weight of the coating, as well as sub-ranges or individual values contained within these ranges). Silver is believed to provide excellent electrical conductivity and may help with mitigating the effects of electrical charges generated by GCRs.

In some instances, the high shielding efficiency material coatings are preferably made of bismuth or have a high bismuth content (such as, at least about 10 to about 99% or about 50 to 99% bismuth by weight of the coating, as well as sub-ranges or individual values contained within these ranges).

In some instances, the high shielding efficiency material coatings are preferably made of tungsten or have a tungsten content (such as, at least about 10 to about 99% or about 50 to 99% tungsten by weight of the coating, as well as sub-ranges or individual values contained within these ranges).

In some instances, such high shielding efficiency material coatings, such as containing silver, aluminum, copper, gold, platinum, zinc, or nickel, may also be employed to shield, reduce, or mitigate from effects of radiation in the form of electromagnetic interference (EMI) either: (1) emitting from structures or devices which are generating electromagnetic (EM) radiation that may interfere with surrounding devices and components; or (2) from EM radiation generated externally that may interfere with the operation of the radiation shielded components devices or structures or signals produced therefrom. In space, this EMI may emanate from high energy sources such as high altitude detonations, high power microwave sources, other electromagnetic pulse sources, as well as other electronic sources/systems. This is sometimes referred to as electromagnetic pulse shielding. In some instances, the high shielding efficiency material coatings act as a sealant or secondary protective layer to reduce intrusion through larger protective enclosures. In these instances, compressibility of these coatings, along with low electrical resistance, may provide a flexible seal to accommodate expansion, manufacturing, or assembly tolerances, or other sources of non-planarity.

### D. Low-Z Material Coating on the Carbon Nanostructure-based Composites

The high shielding efficiency material coating, when present on the vertically aligned carbon nanostructures, as described above, can further be encapsulated by a low-Z material, such as a polymer coating. The low-Z material encapsulant coats the high shielding efficiency material coated array of carbon nanostructures. In preferred instances, the low-Z material fully encapsulates the carbon nanostructure-based composites.

In some other instances, only a low-Z material is present on the vertically aligned carbon nanostructures of the composites without a high shielding efficiency material, such as a high-Z material, coating present thereon. In such instances, the low Z material coating can be achieved by encapsulation with polymer(s) having shielding effectiveness (i.e., high charge to mass ration, like in polymers, such as polyethylene, or polymeric hydrides). In preferred instances, the low-Z material fully encapsulates the carbon nanostructure-based composites. In some instances, the low Z material coating is polyethylene which is rich in hydrogen.

Encapsulation can be viewed as infiltration by the low-Z material wherein the material is permeated through at least some of the carbon nanostructures (i.e., carbon nanotubes) of the arrays, which are optionally conformally coated by a high-Z material. In some embodiments, the extent of infiltration is in the range of 0.1-99.9% of the volume space between the carbon nanostructures (i.e., carbon nanotubes) of the coated arrays. In some instances, infiltration of the coated arrays is complete or essentially complete, wherein essentially complete refers to about 99.9% infiltration of the volume space between the carbon nanostructures.

In some instances, the CNTs may be coated with a low Z-material having a high shielding efficiency per unit mass. For example, hydrogen has some of the highest shielding efficiency per unit mass, and as such low Z materials such as polymers or monomers with a high hydrogen or boron content can be used as low-Z materials. Some examples include hydrocarbons, and may include, without particular limitation, polyethylene (such as low density polyethylene (LDPE) or high density polyethylene (HDPE)), polypropylene, polystyrene, polyimide, polymethyl methacrylate (PMMA), C₂ to C₃₀ alkenes, C₂ to C₃₀ alkanes, and the like, as well as combinations thereof. In some instances, the low Z material coating is polyethylene (such as low density polyethylene (LDPE) or high density polyethylene (HDPE)). Other non-limiting examples of low-Z materials can be made of polymers to form a polymer-based coating from, but not limited, to one or more polymers selected from conjugated polymers, non-conjugated polymers, and/or aromatic polymers. In some instances, the polymer is a thermoplastic elastomer, such as a polyester-based polyurethane or styrene-ethylene-butylene-styrene, polyimide, polyamide, or blends thereof. In some instances, the low-Z material is a paraffin. The polymer-based coating can be spray coated or the array of vertically aligned carbon nanostructures can be dipped into a polymer solution. In some other instances, the polymer-based coating contains one or more oligomeric materials, polymeric materials, or combinations thereof. In certain instances, the polymer may be selected from poly(3,4-3thylenedioxythiophene) poly(styrenesulfonate) (PEDOT:PSS), poly(3,4-3thylenedioxythiophene) (PEDOT), polythiophenes (including alkyl-substituted polythiophenes), polystyrenes, silicones, polysiloxanes, polypyrroles, polyacetylenes, polyanilines, polyfluorenes, polyphenylenes, polypyrenes, polyazulenes, polynaphthalenes, polycarbazoles, polyindoles, polyazepines, poly(3,4-ethylenedioxythiophenes), poly(p-phenyl sulfides), and poly(p-phenylene vinylene), polyacetylenes, polydiacetylenes, and blends thereof. In certain instances, the polymer may be selected from silicones or polysiloxanes. The polymer classes listed above include substituted polymers, wherein the polymer backbone is substituted with one or more functional groups, such as alkyl groups. In some instances, the high shielding efficiency material coating can be formed of one or more low-Z materials selected to provide a higher/greater shielding efficiency than an otherwise equivalent coating formed of polyethylene or paraffin evaluated under the same conditions. The polymers may have any suitable weight average molecular weight or polydispersity. In some instances, the weight average molecular weight may be in a range of between 2,000 Da and 750,000 Da and sub-ranges disclosed therein.

In some instances, the low-Z material can be a polymer which may be an epoxy or polyepoxide. Epoxies can provide a benefit, such as for structural applications, due to their relatively high hydrogen loading, excellent mechanical strength, adhesion properties that may enable stacking of multiple layers of a structural composite, and their resistance to environmental factors such as chemicals, corrosion and temperature resistance.

In some instances, the low-Z material can be made of or contains boron which can be incorporated into polymer matrices of the aforementioned polymers, or can be decorated on carbon nanotube surfaces. In some instances, boron may be introduced metal organic deposition ink methods, as described above, or other suitable methods, such as boron doping by CVD. Boron, for instance, can be a highly effective element for radiation shielding against protons. As noted, boron can be incorporated into composites by doping the carbon nanotube arrays or sheets directly, or by dispersing boron powders into a suitable polymer encapsulant.

### E. Properties of Carbon Nanostructure-Based Composites

In certain instances, the single-layered or multi-tiered carbon nanostructure-based composites described herein have thermal resistances of less than about 5, 4, 3, 2, 1, 1.5, 1.0, 0.9, 0.8, 0.7, 0.6, 0.5, 0.4, 0.3, 0.2, 0.1, 0.05, or 0.01 cm² K/W.

In some instances, the single-layered or multi-tiered carbon nanostructure-based composites described herein have a thermal conductivity in the direction of the carbon nanostructure (i.e., carbon nanotube) alignment in the range of between about 1-2500 W/m·K, 1-2000 W/m·K, 1-1500 W/m·K, 1-1000 W/m·K, 1-500 W/m·K, 5-500 W/m·K, 5-400 W/m·K, 5-300 W/m·K, 5-200 W/m·K, 5-150 W/m·K, or 5-100 W/m·K, or sub-ranges or values disclosed within these ranges.

In some instances, the single-layered or multi-tiered carbon nanostructure-based composites described herein have a thermal transmittance in the range of between about 1000 to 20000 W/m²·K, or sub-ranges or values disclosed within these ranges.

In some instances, the tensile modulus of the single-layered or multi-tiered carbon nanostructure-based composites is in a range of about 0.1 to about 300 GPa.

In some instances, the carbon nanostructure-based composites demonstrate a coefficient of thermal expansion which is at least about 50, 40, 30, 20, or 10% of a coefficient of thermal expansion for an equivalent metallic foil (i.e., aluminum foil) having the same dimensions and thickness.

In still other instances, the carbon nanostructure-based composites demonstrate a total weight which is at least about 50, 40, 30, 20, or 10% less than that of an equivalent metallic foil (i.e., aluminum foil) having the same dimensions and thickness and produces superior thermal and/or radiation shielding properties, by at least about 25, 50, or 75%, than the comparable metallic foil.

In still other instances, the carbon nanostructure-based composites demonstrate a total weight which is at least about 50, 40, 30, 20, or 10% less than that of a metallic foil with equivalent shielding effectiveness (i.e., aluminum foil).

In still other instances, the carbon nanostructure-based composites demonstrate a shielding efficiency per unit mass that is at least 50, 40, 30, 20, or 10% that of an equivalent mass of polymer film while exhibiting superior structural or mechanical properties than the polymer film.

In still other instances, the carbon nanostructure-based composites demonstrate a shielding efficiency per unit mass that is at least 99, 95, 90, 80, 70, 60, or 50% that of an equivalent thickness of polymer film while exhibiting superior structural or mechanical properties than the polymer film, especially when exposed to radiation.

In some instances, the carbon nanostructure-based composites can provide a radiation shielding property from terrestrial/environmental or space radiation. It is believed that a periodic low-Z carbon nanostructure/high-Z material/low-Z material motif, as found in certain nanostructure-based composites described can provide shielding against protons, electrons, neutrons, and/or photons (e.g., χ- and γ-rays). In some instances, the carbon nanostructure-based composites shield against solar particle events (SPEs) and galactic cosmic rays (GCRs).

Typically, the carbon nanostructure-based composites are conformable, deformable, or compliant composites, when applied or contacted, optionally under pressure, with one or more surfaces of another material or device. The single-layered and multi-tiered carbon nanostructure-based composites can also be considered flexible. For example, the carbon nanostructure-based composites can be more ductile than either the high-Z or low-Z materials present therein by themselves. This can be due to the anisotropic structure properties of the carbon nanostructures (i.e., carbon nanotubes) present in the laminate composite. Such properties of conformability, deformability, and/or flexibility can be valuable for fabricating radiation shielding materials into lightweight and complex structural components.

The carbon nanostructure-based composites can be shock absorbing and vibration dampening. They may be impact resistant. The composites can be stamped, bent, or formed to create other structures, as desired. They can be cut to precise dimensions with common cutting techniques, such as metal cutting, die, or laser cutting techniques known. They may be assembled into structures using fasteners (such as bolts), rivets, or adhesives. They may be bonded to honeycomb panels as face sheets to form structural elements. They can have a sufficient electrical conductivity capable of grounding electrical components or of dissipating electrical charges generated from GCRs. They may be resistant to high temperatures experienced in orbit, for example when in a sun facing orbit, with the ability to withstand temperatures greater than about 200, 300,400, 500, or 600 degrees Celsius.

As described below, in some instances, the carbon nanostructure-based composites, which are considered single-layered composites, may be stacked to form multi-tiered carbon nanostructure-based composites. It is expected that such multi-tiered carbon nanostructure-based composites having, for example, 2-, 3-, 4-, 5-, 6- or more tiers, would demonstrate the properties specified immediately above.

### F. Multi-Tiered Carbon Nanostructure-Based Composites

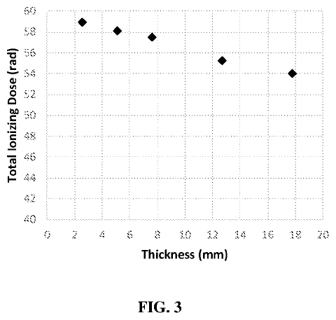

The carbon nanostructure-based composites, which are considered single-layered composites, may be stacked according to the methods described below to multi-tiered carbon nanostructure-based composites, as shown in FIG. 3.

In some instances, a multi-tiered carbon nanostructure-based composite is formed by contacting/stacking at least two single-layered carbon nanostructure-based composites. In particular instances, the number of single-layered carbon nanostructure-based composites is selected to provide multi-tiered carbon nanostructure-based composites having at least 2, 3, 4, 5, or more tiers. FIG. 3 shows a non-limiting representation of a three-tiered nanostructure-based composite. It is noted that the three-tiered nanostructure-based composite would be considered a laminate which is planar because the single-layered carbon nanostructure-based composites are planar composites. In some instances, pressure, heat, and/or vacuum may be applied during the stacking process.

By using more single-layered carbon nanostructure-based composites the thickness of the multi-tiered carbon nanostructure-based composites can be increased, as needed. The thickness of the resulting multi-tiered carbon nanostructure-based composites formed by stacking can be in the range 1-10,000 microns or more. In some embodiments, the thickness of the resulting multi-tiered carbon nanostructure-based composites formed by stacking can be 1-3,000 micrometers or 70-3,000 micrometers. In some embodiments, the number of tiers and/or thickness is based on the thickness of the CNT forest formed on the arrays of the single-layered carbon nanostructure composites used in the stacking process.

In some instances, the weight of the multi-tiered carbon nanostructure-based composites described herein have a weight which is about 10, 20, 30, 40, or 50% less of the weight of a metallic sheet (such as made of aluminum) having the same size and thickness but provides superior shielding effectiveness properties, as compared to the comparable metallic sheet.

In certain instances, stacking single-layered carbon nanostructure-based composites can produce interdigitation of bundles of carbon tubes that were clumped during the assembly step. There may also be some interdigitation of the free tips of carbon nanotubes between stacked arrays, such as when they bonded at high pressures. In some instances, interdigitation, as used herein, refers to the degree which one or more individual nanostructure elements of an array or sheet infiltrate or penetrate into the adjacent nanostructure elements of another array or sheet when the two different arrays or sheets are contacted or stacked. In some instances, interdigitation refers to the penetration of microstructures formed from pre-clumping of CNT nanostructures, into one another. In some cases, the extent or degree of interdigitation, of either type, can be measured and is in a range of about 0.1% to 99% or at least about 1%, 5%, 10%, 20%, 30%, 40%, 50%, 60%, 70%, 80%, 90%, or 95%.

In some instances, an adhesive or epoxy can be applied to the single-layered carbon nanostructure composites prior to being stacked. In such cases, the thickness of the adhesive or epoxy can be about 1-100,000 nm, 1-50,000 nm, 1-10,000 nm, or 1 to 5,000 nm. In still other instances, stacking may occur after the low-Z material coating or encapsulation step used to prepare the single-layered carbon nanostructure composites. In such instances, the low-Z material may be a crosslinkable or curable polymer, which acts as an adhesive, allowing for single-layered carbon nanostructure composites to be stacked to form multi-tiered carbon nanostructure-based composites having at least 2, 3, 4, 5, 6, or more tiers.

### III. Methods of Preparing Single-Layered and Multi-Tiered Carbon Nanostructure-Based Composites

In one non-limiting instance of a method of forming a single-layered carbon nanostructure-based composite, the method includes the steps of:
(1) forming or providing a vertically aligned carbon nanostructure array on a preferably high-Z substrate or support;
(2) optionally depositing or forming at least one high shielding efficiency material coating on the carbon nanostructures of the array of step (1); and
(3) forming a low-Z material coating on the vertically aligned carbon nanostructure array to provide a single-layered carbon nanostructure-based composite.

In some instances of the above method, the low-Z material coating formed in step (3) encapsulates the single-layered carbon nanostructure-based composite formed. In some other instances of the above method, step (1) above is substituted by a step of forming or providing a vertically aligned carbon nanostructure sheet, with all other steps remaining as shown except for referring to carbon nanostructures of the sheet and vertically aligned carbon nanostructure sheet in place of carbon nanostructures of the array and vertically aligned carbon nanostructure sheet, respectively.

In another non-limiting instance of a method of forming a single-layered carbon nanostructure-based composite, the method can include the steps of:
(1′) forming or providing a vertically aligned carbon nanostructure array on a preferably high-Z substrate or support;
(2′) depositing or forming at least one high shielding efficiency material coating on the carbon nanostructures of the array of step (1′); and
(3′) encapsulating the high-Z material coated carbon nanostructures of the array with a low-Z material to provide a single-layered carbon nanostructure-based composite.

In some other instances of the above, step (1′) above is substituted by a step of forming or providing a vertically aligned carbon nanostructure sheet, with all other steps remaining as shown except for referring to carbon nanostructures of the sheet in place of carbon nanostructures of the array.

The high shielding efficiency material coating formed in step (2) or (2′) is preferably a conformal coating over all or substantially all of the carbon nanostructures of the array, where “substantially all” refers to at least 80, 90, 95, or 99% of the carbon nanostructure surfaces being conformally coated by the high shielding efficiency. In some instances, the high shielding efficiency material coating formed in step (2) or (2′) is a high-Z material coating.

The high shielding efficiency material coating can be formed of, but is not limited to, a metal, metal alloy, and/or a metal oxide. In some instances, the metal can be, but is not limited to, aluminum, bismuth, cobalt, chromium, zinc, gallium, tantalum, platinum, gold, nickel, iron, tin, lead, silver, tungsten, titanium, indium, copper, antimony, zirconium, titanium, lithium, palladium or combinations or alloys thereof and/or one or more metal oxides, such as oxides of the metals listed above or metal hydrides such as hydrides of the metals above. In some instances, the conformal coating is not a continuous film, but instead a dense decoration of individual nanoparticles along the length of the carbon nanotube from tip to root. In some instances, the high shielding efficiency material coating need not be a conformal coating but instead may exist only at or near the tips of the array.

In some other instances the high shielding efficiency material may be dispersed throughout the thickness of the array, without forming a continuous film.

In certain instances, the low-Z carbon nanostructures (i.e., carbon nanotubes) are conformally coated by a high shielding efficiency material at the sidewalls of the CNTs and optionally at the tips of the carbon nanostructures (i.e., carbon nanotubes) or vice versa. In certain other instances, the carbon nanostructures (i.e., carbon nanotubes) are conformally coated by the high shielding efficiency material at both the sidewalls of the carbon nanostructures (i.e., carbon nanotubes) and at the tips of the carbon nanostructures (i.e., carbon nanotubes).

In certain instances, at least about 100%, 99%, 98%, 97%, 96%, 95%, 90%, 80%, 70%, 60%, 50%, 40%, 30%, 20%, or 10% of the low-Z carbon nanostructures (i.e., carbon nanotubes) surface is coated by a high shielding efficiency material coating. In certain non-limiting instances, the thicknesses of the high shielding efficiency material coating, such as nanoscale conformal coating, can range from about 0.1 to 50,000 nanometers, 500 to 50,000 nanometers, 1 to 10,000 nanometers, 5 to 5,000 nanometers, 5 to 1,000 nanometers, 5 to 500 nanometers, 5 to 250 nanometers, 0.1 to 1,000 nanometers, 1 to 500 nanometers, 5 to 250 nanometers, more preferably 5 to 100 nanometers, 5 to 50 nanometers, or 5 to 25 nanometers.

In some instances of the methods, polymers or monomers with a high hydrogen or boron content can be used as low-Z materials. Some examples include hydrocarbons, and may include, without particular limitation, polyethylene (such as LDPE or HDPE), polypropylene, polystyrene, polyimide, polymethyl methacrylate (PMMA), C₂ to C₃₀ alkenes, C₂ to C₃₀ alkanes, and the like, as well as combinations thereof. In some instances, the low Z material coating is polyethylene (such as low density polyethylene (LDPE) or high density polyethylene (HDPE)). Other non-limiting examples of low-Z materials can be made of polymers to form a polymer-based coating from, but not limited, to one or more polymers selected from conjugated polymers, non-conjugated polymers, and/or aromatic polymers.

In some instances, the polymer is a thermoplastic elastomer, such as a polyester-based polyurethane or styrene-ethylene-butylene-styrene, polyimide, polyamide, or blends thereof. In some instances, the low-Z material is a paraffin. The polymer-based coating can be spray coated or the array of vertically aligned carbon nanostructures can be dipped into a polymer solution. In some other instances, the polymer-based coating contains one or more oligomeric materials, polymeric materials, or combinations thereof. In certain instances, the polymer may be selected from poly(3,4-3thylenedioxythiophene) poly(styrenesulfonate) (PEDOT:PSS), poly(3,4-3thylenedioxythiophene) (PEDOT), polythiophenes (including alkyl-substituted polythiophenes), polystyrenes, silicones, polysiloxanes, polypyrroles, polyacetylenes, polyanilines, polyfluorenes, polyphenylenes, polypyrenes, polyazulenes, polynaphthalenes, polycarbazoles, polyindoles, polyazepines, poly(3,4-ethylenedioxythiophenes), poly(p-phenyl sulfides), and poly(p-phenylene vinylene), polyacetylenes, polydiacetylenes, and blends thereof. In certain instances, the polymer may be selected from silicones or polysiloxanes. The polymer classes listed above include substituted polymers, wherein the polymer backbone is substituted with one or more functional groups, such as alkyl groups. In some instances, the high shielding efficiency material coating can be formed of one or more low-Z materials selected to provide a higher/greater shielding efficiency than an otherwise equivalent coating formed of polyethylene or paraffin evaluated under the same conditions. The polymers may have any suitable weight average molecular weight or polydispersity. In some instances, the weight average molecular weight may be in a range of between 2,000 Da and 750,000 Da and sub-ranges disclosed therein.

In some instances, the low-Z material can be a polymer which may be an epoxy or polyepoxide. Epoxies can provide a benefit, such as for structural applications, due to their relatively high hydrogen loading, excellent mechanical strength, adhesion properties that may enable stacking of multiple layers of a structural composite, and their resistance to environmental factors such as chemicals, corrosion and temperature resistance.

In some instances, the low-Z material can be made of or contains boron which can be incorporated into polymer matrices of the aforementioned polymers, or can be decorated on carbon nanotube surfaces. In some instances, boron may be introduced via metal organic deposition ink methods, as described above, or other suitable methods, such as boron doping by CVD.

The low Z-material coating or encapsulant formed in steps (3) or (3′) of the methods, may be a polymer-based coating, which can be spray coated or the array of vertically aligned carbon nanostructures can be dipped into a polymer solution. In some other instances, the low Z-material may be direct coated via film or knife coating. In some cases, the low Z-material coating may be applied via a roll coater, such as gravure or reverse roll coating. The polymer solution can be prepared in a suitable solvent for one or more polymers dissolved therein. The solvents can be organic solvents, such as tetrahydrofuran, xylenes, tert-Butyl acetate, acetone, ethyl acetate, or pyridine. The concentration of polymer in the polymer solution is not particularly limited and can, as an example, be in a range of about 0.1 to 50 wt % by volume of solvent(s), but other concentrations are possible.

Optionally heating, cooling, and/or vacuum may be applied to control or promote removal of the solvent during steps (3) or (3′) of any of the methods described herein. In some instances, the polymer solution may be heated or melted to enable infiltration of the polymer(s) into the CNT array. In some other instances, the polymer-based coating contains one or more oligomeric materials, polymeric materials, or combinations thereof. In the methods described herein, steps (3) or (3′) can be performed for a period of time as needed to ensure infiltration of the low-Z material onto the carbon nanostructures of the array and to adequately coat or encapsulate the composite. In some instances, the time period can be in the range of about 0.1-200 minutes, about 15-150 minutes, or about 20-120 minutes. In certain instances, the infiltration time can be between about 0.1-5 minutes or 0.1-10 minutes. Standing times may be varied as necessary depending on the choice of low-Z encapsulant material. In some instances, the low-Z material polymer will cure or crosslink after infiltration. In some instances, multiple layered composites can be formed where multiple single-layered composites are stacked before curing of the low-Z material polymer to make a multi-tiered composite, as described in detail elsewhere herein. In some instances, the low-Z material polymer in steps (3) or (3′) of the methods may be heated to accelerate curing.

The single-layered carbon nanostructure-based composites can have any suitable shape or dimensions (i.e., length, width, diameter, etc.), but square or rectangular shapes are generally preferred. The single-layered carbon nanostructure-based composites may be cut, punch pressed, stamped, molded, or otherwise used to form any shape desired having any dimensions required.

In yet another non-limiting instance, a method of forming a multi-tiered carbon nanostructure-based composite can include the steps of:
(1″) forming or providing at least two vertically aligned carbon nanostructure arrays each on a substrate or support;
(2″) optionally depositing or forming at least one high shielding efficiency material coating on the carbon nanostructures of each of the at least two arrays of step (1″); and
(3″) forming a low-Z material coating on each of the at least two arrays to provide at least two single-layer carbon nanostructure-based composites, wherein the low-Z material is a curable or crosslinkable material; and
(4″) stacking the at least two single-layer carbon nanostructure-based composites of step (3″) and crosslinking or curing the low-Z material coating to provide a multi-tiered carbon nanostructure-based composite.

In some other instances of the above method, step (1″) above is substituted by a step of forming or providing at least two vertically aligned carbon nanostructure sheets, with all other steps remaining as shown except for referring to carbon nanostructures of each of the at least two sheets and at least two sheets in place of carbon nanostructures of each of the at least two arrays and at least two arrays, respectively.

In some instances, steps (3″) and (4″) above can be performed concurrently. In some instances, step (4″) includes the application of heat, vacuum, and/or pressure. Heating may range from about 70-275° C., 70-250° C., 70-200° C., 70-150° C.; vacuum may be applied at a pressure which causes air bubbles/pockets to be eliminated, and pressure may be in a range of about 1 to 100 psi or 10 to 60 psi, as well as sub-ranges and individual values contained within the aforementioned heat, vacuum, and pressure ranges.

Details of the high shielding efficiency material coating, which can be a conformal coating, and the low-Z material coating are as described above. In some instances, the high shielding efficiency material coating is a high-Z material, as described herein. In certain instances, where the low-Z material is a curable or crosslinkable polymer and can act as an adhesive the low-Z material is a polymer or blend of polymers, such as selected from epoxies, silicones, or acrylics. The curable or crosslinkable polymer may be thermally or photochemically cured/crosslinked during the method using techniques/conditions and initiators, as needed, known in the art.

In still another non-limiting instance, a method of forming a multi-tiered carbon nanostructure-based composite can include the steps of:
(1′″) forming or providing at least two vertically aligned carbon nanostructure arrays each on a substrate or support;
(2′″) optionally depositing or forming at least one high shielding efficiency material coating on each of the carbon nanostructures of the at least two arrays of step (1′″);
(3′″) forming a low-Z material coating on each of the at least two arrays to provide at least two single-layer carbon nanostructure-based composites;
(4′″) applying an adhesive coating layer onto each of the at least two single-layered carbon nanostructure-based composites; and
(5′″) stacking the at least two single-layer carbon nanostructure-based composites of step (4′″) to provide a multi-tiered carbon nanostructure-based composite.

In some other instances of the above method, step (1′″) above is substituted by a step of forming or providing at least two vertically aligned carbon nanostructure sheets, with all other steps remaining as shown except for referring to carbon nanostructures of each of the at least two sheets and at least two sheets in place of carbon nanostructures of each of the at least two arrays and at least two arrays, respectively.

In some instances of the above method, the adhesive coating layer is formed of or include a thermoplastic or thermosetting polymer to enable bonding of the at least two single-layered carbon nanostructure-based composites. In some instances, step (5′″) includes the application of heat, vacuum, and/or pressure. Heating may range from about 70-250° C., 70-200° C., 70-150° C.; vacuum may be applied at a pressure which causes air bubbles/pockets to be eliminated, and pressure may be in a range of about 1 to 100 psi or 10 to 60 psi, as well as sub-ranges and individual values contained within the aforementioned heat, vacuum, and pressure ranges.

Details of the high shielding efficiency material coating, which can be a conformal coating, and the low-Z polymer encapsulant are as described above. In certain instances where an adhesive is applied to the at least two single-layered carbon nanostructure-based composites the adhesive is selected from an epoxy, silicones, or acrylics. The adhesive may be qualified for use in space conditions. In such cases, the thickness of the adhesive can be about 1-10,000 nm, 1-5000 nm, 1-1000 nm, 1-500 nm, or 1-100 nm, as well as sub-ranges and individual values contained within.

In particular instances of the methods to make multi-tiered carbon nanostructure-based composites, the number of single-layered carbon nanostructure-based composites used, such as 2, 3, 4, 5, 6, or more provide a multi-tiered carbon nanostructure-based composites having an equal number of tiers, that is 2, 3, 4, 5, 6, or more tiers. The multi-tiered carbon nanostructure-based composites can be considered laminates which are planar because the multiple single-layered carbon nanostructure-based composites, which are planar composites, produce a planar laminate of the multi-tiered carbon nanostructure-based composite. In some instances, pressure may be applied during the stacking of steps (4″) and (5′″). Pressure during stacking may be in a range of about 1 to 100 psi or 10 to 60 psi, as well as sub-ranges and individual values contained within.

The thickness of the resulting multi-tiered carbon nanostructure-based composites formed by stacking can be in the range 1-10,000 microns or more. In some embodiments, the thickness of the resulting multi-tiered carbon nanostructure-based composites formed by stacking can be 1-3,000 micrometers or 70-3,000 micrometers. In some embodiments, the number of tiers and/or thickness is based on the thickness of the CNT forest formed on the arrays of the single-layered carbon nanostructure composites used in the stacking process.

The multi-tiered carbon nanostructure-based composites formed by stacking are typically planar and can be considered laminates. The laminates can have any suitable shape or dimensions (i.e., length, width, diameter, etc.), but square or rectangular shapes are preferred. The planar laminates resulting from the stacking process may be cut, punch pressed, molded, stamped, or otherwise used to form any shape desired having any dimensions required.

In the methods described above, the at least one high-Z material coating, which is optionally conformal, can be applied using atomic layer deposition (ALD). In some other instances, one or more coatings of the high-Z material can be vapor deposited onto the plurality of vertically aligned d carbon nanostructures (i.e., carbon nanotubes) forming the arrays, such as, via chemical vapor deposition (CVD) to form such coating(s). In still other instances, one or more coatings of the high-Z material can be vapor deposited onto the plurality of vertically aligned carbon nanostructures (i.e., carbon nanotubes) forming the arrays, such as, via sputtering in order to form such coating(s).

ALD is preferred in certain instances and can be used to deposit the desired high-Z material coating with high conformity and precise control of the thickness. The deposition is controlled at the atomic level by self-limiting surface reactions. Consequently, uniform and conformal deposition will occur on high aspect ratio porous structures because of self-passivating of the surface chemistry. Once the reaction is completed at one surface site, the reactants will continue to travel down the high aspect ratio pore and reach unreacted surface sites.

Methods of ALD, CVD, and sputter coating metal-based coating and the reaction conditions and equipment needed to achieve such metal-based coatings are well-known in the art. The selection of appropriate metal precursors for formation of desired metal-based coatings made of, but not limited to, aluminum, bismuth, cobalt, chromium, zinc, gallium, tantalum, platinum, gold, nickel, iron, tin, lead, silver, tungsten, titanium, indium, copper, antimony, zirconium, titanium, lithium, palladium, or alloys/combinations are also known.

For example, for vapor deposition methods used to deposit one or more coatings on the carbon nanostructures, generally, gas precursors containing the source material of the coating are deposited, such as by CVD or ALD fed into a closed chamber containing the encapsulated array. The chamber can be at atmospheric pressure or at various grades of vacuum. The chamber walls can be hot or a heated stage can be used with cold chamber walls to increase the deposition rate on the target object (i.e., CNTs of the array). Methods of forming thin films via CVD are well known in the art. See, for example, S. A. Campbell, Science and Engineering of Microelectronic Fabrication, 2^{nd} Edition, Oxford University Press, New York (2001); incorporated herein in its entirety by reference. CVD deposition techniques of metals, as well as CVD deposition of metal oxides, such as aluminum oxide and silicon oxide are known. In certain instances, CVD deposition rates can be as low as 1 nm/cycle.

In some instances, the high Z-material coating can be multi-layer coating, where, for example, each layer may perform more than one function, such that there are two or more of the aforementioned high-Z material layers.

In certain non-limiting examples, the surface of the plurality of vertically aligned carbon nanostructures (i.e., carbon nanotubes) forming the arrays are coated via ALD with a tungsten (W) coating. The tungsten conformal coating may have any suitable thickness but may be, in some instances, in a range of between about 1 to 300 nm, 1 to 200 nm, 1 to 100 nm, 5 to 100 nm, 5 to 75 nm, or 5 to 50 nm, as well as sub-ranges or individual values contained within these ranges. In some instances, the coating is a 20 nm thick coating. A common limitation in metal deposition using ALD is the availability of reducing agents that can adsorb and react exothermically with surface-adsorbed metal precursors allowing ALD to proceed at temperatures <350° C. Of all ALD metal deposition processes, ALD tungsten (W) is a thermodynamically favorable process that uses, for example, tungsten hexafluoride (WF₆) and silane (SiH₄) or disilane (Si₂H₆) as reactants. An advantage of using W, which is a high-Z material, as the metal coating in some instances is that its high atomic number makes the resultant composite effective at preventing transmission of radiation. This is especially valuable for applications such as protection of electronics that must operate in environments such as space, where cosmic radiation bombardment is common.

In certain other instances of the methods above, the one or more coatings of a high shielding efficiency material can be applied using a wet coating method, such as metal organic deposition (MOD) ink methods (see for instance, Choi, et al., Adv. Mater. Interfaces, 2019, 6, 1901002). In such methods, the surface of the plurality of vertically aligned carbon nanostructures (i.e., carbon nanotubes) forming the arrays is infiltrated with a liquid phase containing metal precursors which can be decomposed thereby forming and depositing metal, and/or metal oxides, on the surface of carbon nanostructures (i.e., carbon nanotubes), particularly at any defect sites present which promote metal formation/deposition from the precursors. The decomposition of the metal precursors and formation of the metal-based coating therefrom is usually achieved by submerging the carbon nanostructures (i.e., carbon nanotubes) forming the arrays into an appropriate solvent (such as xylenes or limonene) containing the metal precursor(s) dissolved therein and applying heat, under an inert environment, to thermally decompose the metal precursor(s) and form the coating. Exemplary precursors include, but are not limited to, metal isopropoxides, metal hydrides (such as, without limitation, titanium hydride, AlH₃{O(C₄H₉)₂, AlH₃{N(CH₃)₃}), galistan, and metal salts. Metal salts can include, without limitation, silver nitrate, silver neodecanoate, silver oxalate, silver acetate, silver tartarate, silver hexafluoroacetylacetonate cyclooctadiene, bismuth 2-ethylhexanoate (bismuth Octoate), and bismuth nitrate Bi(NO₃)₃, tetraethyldibismuthine, boric acid (hydrogen borate), tungsten hexacarbonyl, copper acetate, copper formate tetrahydrate, copper formate, copper glycolate, copper lactate, copper oleate, copper hydroxide, nickel sulfate, nickel formate dihydrate, and nickel acetate. In some cases, the metal precursors are silver salts. In some other cases, the metal precursors are bismuth salts. Suitable conditions and parameters (solvents, concentrations, temperatures, heating times, etc.) used with MOD inks are known. In some instances, the MOD inks (such as metal salts) can have a concentration of about 5 to about 50% wt/wt of a suitable solvent. In some instances, bismuth 2-ethylhexanoate (C₂₄H₄₅BiO₆, BiEH) is used as precursor salt ink for an MOD process to deposit bismuth (such as Bi₂O₃) onto the surface of carbon nanostructures (i.e., carbon nanotubes). Suitable precursors and metal salts can be mixed with a solvent(s) to form an MOD ink solution, where solvent(s) and precursors/metal salts concentration can be used control the liquid rheology and control the coating uniformity on the onto the surface of carbon nanostructures (i.e., carbon nanotubes). After coating the CNTs with the MOD ink solution, carbon nanostructures (i.e., carbon nanotubes) can be heated to at least about 150° C., 175° C., 200° C., 225° C., or 250° C. for at least about 20, 25, 30 minutes, or longer, under a vacuum, which causes the precursors/metal salts present to decompose into metal, or oxides thereof, and coat the surfaces of carbon nanostructures (i.e., carbon nanotubes). In some instances, a binder may be added to the MOD inks to modify the rheology (viscosity) of the mixture and aid in depositing the ink due to the viscosity and flow characteristics. In certain stances, the CNT array may first be wetted with a solvent to pre-clump it (i.e., induce clumping of the CNTs present) and the solvent evaporated or dried, and then followed by application of the MOD ink to the clumped CNT array to access more surface area than would otherwise be accessible via direct liquid coating without pre-clumping. In some instances, when using an MOD ink, the CNTs of the arrays may be first coated with a suitable polymer, such as those named elsewhere herein, to promote or improve uniformity and/or conformality of the coating formed using an MOD process.

In still other instances of the methods, the one or more coatings of a high shielding efficiency material can be applied using deposition via nanoparticle inks, which are dissolved in a suitable solvent, such as organic, aliphatic, or aromatic solvents, and then the solvent evaporated. As may be appropriate, additives or excipients, such as surfactants, may be added to the solvent(s) to promote dispersion of the nanoparticles therein. Non-limiting nanoparticles can be metal containing nanoparticles, metal oxide nanoparticles, or combinations thereof known in the art. Such nanoparticles can be Ag, Cu, Ni, W, Bi type nanoparticles. The nanoparticles can have any suitable dimensions or shape, and can be obtained from commercial sources or synthesized according to art known methods. In some cases, the nanoparticle inks are silver nanoparticle inks. In certain stances, the CNT array may first be wetted with a solvent to pre-clump it (i.e., induce clumping of the CNTs present) and the solvent evaporated or dried, and then followed by application of the nanoparticle ink to the clumped CNT array to access more surface area than would otherwise be accessible via direct liquid coating without pre-clumping.

In yet other instances of the methods above, the one or more coatings of a high shielding efficiency material, containing metals described elsewhere, can be applied using hydrothermal decomposition methods. Such methods are described in Everhart, B., et al., (2020). Hydrothermal synthesis of carbon nanotube-titania composites for enhanced photocatalytic performance. Journal of Materials Research, 35(11), 1451-1460.

### A. Carbon Nanostructure Arrays

Exemplary methods of forming carbon nanostructure (i.e., carbon nanotube) arrays or sheets of steps (1), (1′) (1″), or (1′″) in the above methods are described below. Alternate methods of making such arrays or sheets are also known in the art.

In certain instances, the carbon nanostructures are tubular structures (i.e., carbon nanotubes) which form vertically aligned forests or arrays. In particular instances, the vertically aligned carbon nanostructures are single, double, triple, or higher order multi-walled carbon nanotubes.

In some instances, the vertically aligned carbon nanotube arrays, are supported on, or, alternatively, attached to, the surface of support or substrate, formed at least in part from a metal, such as, but not limited to, aluminum, cobalt, chromium, zinc, tantalum, platinum, gold, nickel, iron, tin, lead, silver, titanium, indium, copper, or combinations thereof and/or one or more metal oxides, such as oxides of the metals listed above. In other instances, support materials can be, but are not limited to, ceramics and silicon or silicon compounds, such as silicon dioxide. In certain other instances, the substrate or support is a metallic foil, such, but not limited to, aluminum foil or copper foil.

The arrays can be formed via any suitable method known in the art for forming such arrays or forests on a substrate. In preferred instances, the array is formed of vertically aligned carbon nanostructures on a support or substrate. The carbon nanostructures are said to be “vertically aligned” when they are substantially perpendicular to the surface on which they are supported or attached. Carbon nanotubes are said to be substantially perpendicular when they are oriented on average within 30, 25, 20, 15, 10, or 5 degrees of the surface normal. Preferably, the nanotubes are spaced at optimal distances from one another and are of uniform height. In certain instances, the diameters of the carbon nanostructures is in the range from 10 to 40 nm, more preferably 15 to 30 nm, most preferably about 20 nm or less. The length of carbon nanostructures (i.e., carbon nanotubes) which form the arrays can range from 0.01 to 5,000 microns, preferably 0.1 to 2500 microns, preferably 0.1 to 2000 microns, more preferably 0.1 to 1000 microns. In other instances, the carbon nanostructures form, but are not limited to, fibers, wires, horns, cones, or other tube-shaped structures having a high aspect ratio (i.e., greater than 1) with lengths as described above.

In preferred instances, the carbon nanostructures (i.e., carbon nanotubes) are grown at a growth temperature that is less than the melting temperature of the metal or metal alloy substrate or support. In certain instances, the carbon nanostructures are grown at a growth temperature of between about 600° C. and about 660° C., more preferably between about 610° C. and about 650° C., most preferably between about 620° C. and about 640° C.

Any suitable carbon source gas may be utilized. In some instances, the carbon source gas is acetylene. Other suitable carbon source gases include ethene, ethylene, methane, n-hexane, alcohols, xylenes, metal catalyst gases (e.g., carbonyl iron), and combinations thereof.

In certain other instances, arrays of vertically aligned carbon nanostructures (i.e., carbon nanotubes) are fabricated on another surface, and can be transferred, using methods known in the art, to a support or substrate made of a metal, metal alloy, ceramic, silicon-based, or other suitable material.

In some instances, the carbon nanostructure (i.e., carbon nanotube) array is formed on one or both sides of the substrate or support. In preferred instances, the carbon nanostructure (i.e., carbon nanotube) array is formed on both sides of the substrate or support.

Carbon nanotube sheets can be prepared using techniques well known in the art. In one instance, the sheets are prepared as described in U.S. Pat. No. 7,993,620 B2. In this instance, CNT agglomerates are collected into sheets in-situ inside the growth chamber on metal foil substrates. The sheets can then be densified by removing the solvent. In another instance, the CNT sheets are made by vacuum filtration of CNT agglomerates that are dispersed in a solvent.

### IV. Uses of Single-Layered and Multi-Tiered Carbon Nanostructure-Based Composites

The single-layered and multi-tiered carbon nanostructure-based composites described herein can be used in various applications, such as radiation shielding applications. Such radiation shielding can be used in terrestrial or space applications, such as space missions including lunar missions or space missions beyond Earth and lunar orbit.

In some instances, the single-layered and multi-tiered carbon nanostructure-based composites can provide a radiation shielding property which protects structural and/or electronic components from terrestrial/environmental or space radiation. These structural and/or electronic components may be, for example, in spacecraft and/or space satellites. It is believed that the periodic low-Z carbon nanostructure/high-Z material/low-Z material motif found in the single-layered and multi-tiered carbon nanostructure-based composites provides excellent shielding against protons, electrons, neutrons, and/or photons (e.g., χ- and γ-rays). For lunar missions, for example, the effectiveness of radiation shielding can result from a high-Z material to counter high-energy photons and a low-Z material for blocking protons and neutrons. In some instances, the single-layered and multi-tiered carbon nanostructure-based composites shield against solar particle events (SPEs) and galactic cosmic rays (GCR). This is especially valuable for applications such as protection of electronics that must operate in environments such as space, where cosmic radiation bombardment is common. It is expected that the single-layered and multi-tiered carbon nanostructure-based composites disclosed attenuate the energy and flux of ionizing radiation as it passes through the composite material, such that the energy per unit mass (or dose) absorbed is sufficiently below the maximum dose ratings of electronic and/or structural components, which may be present.

In certain instances, the single-layered and multi-tiered carbon nanostructure-based composites may be used at temperatures which are above ambient temperature, at ambient temperature, below ambient temperature, below freezing, or at cryogenic temperatures.

In certain instances, the single-layered and multi-tiered carbon nanostructure-based composites described may be placed or affixed on electronic components such as, but not limited to, personal computers, server computers, memory modules, graphics chips, radar and radio-frequency (RF) devices, disc drives, displays, including light-emitting diode (LED) displays, lighting systems, automotive control units, power-electronics, solar cells, batteries, communications equipment, such as cellular phones, thermoelectric generators, and imaging equipment, including MRIs.

In some instances, the single-layered and multi-tiered carbon nanostructure-based composites may be used as a structural material to build spacecraft. The material may serve as a shield for human (or other living passengers) from the effects of radiation. The spacecraft structures may also protect onboard equipment from radiation.

### EXAMPLES

### Example 1: Fabrication of CNT Arrays Coated with Bismuth (Bi) and Polyethylene for Radiation Shielding

### Sample Fabrication:

In this example, bismuth (Bi), a heavy element (high Z-material) with mass attenuation properties similar to that of lead (Pb), was coated onto aligned CNT arrays for blocking high energy photons and electrons. The coated array was encapsulated with an encapsulant polymer (low Z-material), low density polyethylene (LDPE). LDPE has high hydrogen content which makes it suitable for attenuating protons, neutrons, and alpha particles.

First, sheets of vertically aligned CNTs were prepared. CNTs were grown on both sides of an aluminum foil substrate. The CNT heights ranged from 75 to 100 m per side. The CNT array sheets were then coated in Bi before being encapsulated in a polymer.

In this example, a metal-organic decomposition (MOD) ink technique, which is a solution-based and highly scalable process, was employed to deposit bismuth on the CNT array sheets. Bismuth 2-ethylhexanoate (C₂₄H₄₅BiO₆, BiEH) was selected as a precursor bismuth salt (MOD ink) and was mixed with solvent, such as xylenes or limonene, at a 50% wt/wt of Bi salt to solvent to control the liquid rheology and control the coating uniformity. After coating the CNTs of the array with the BiEH solution, the CNT sheets were heated to 250° C. for 30 min under vacuum, during which the BiEH decomposed into Bi₂O₃ and coated the CNT arrays.

Bi-coated CNT arrays were prepared and then encapsulated in a meltable LDPE homopolymer wax. Two samples of multilayer stacks of 5000±130 μm and 2500±100 μm in thickness were then produced by stacking infiltrated layers and bonding them under heat and in a vacuum to eliminate air pockets.

### Characterization:

For testing the effect of thickness on shielding efficacy, the two samples prepared with nominal total stacked thicknesses in intervals of about 2500 μm were evaluated. The average density of the fabricated samples was 1.45 g/cm³. The final elemental composition estimates for both samples is summarized in the table below:

TABLE 1
Elemental Mass Compositions of the CNT/Bi/LDPE
Radiation Shielding Samples

| | 2500 μm - Mass | 5000 μm - Mass |
|---|---|---|
| Element | Percentage | Percentage |
| H | 5.1% | 5.2% |
| C | 43.8% | 44.2% |
| O | 1.1% | 1.1% |
| Al | 40.7% | 40.3% |
| Bi | 9.4% | 9.3% |

### Radiation Efficacy Results and Discussion:

Total ionizing dose (TID) testing was conducted to evaluate the radiation shielding efficacy of the two samples. TID measurements were obtained using radiation-sensitive field-effect transistors (RADFETs) as dosimeters (see Asensio, et al., Sensors and Actuators A, 125, p. 288 (2006)). The two samples were exposed to a Cobalt-60 (Co-60) radiation source emitting gamma radiation with peaks at 1.17 MeV and 1.33 MeV. Comparisons were made between the samples with and without shielding, as well as against pure lead as a reference material.

As shown in FIG. 3, the TID decreases linearly as a function of sample thickness, illustrating the expected increase in shielding efficacy. For the different thicknesses shown between about 2 and 18 mm, these represent appropriate stacks of individual 2500 μm and 5000 μm samples to achieve the specified thickness. When stacked, the stacks did not include any bonding between them. The relative shielding effectiveness of the CNT/Bi/LDPE samples was found to be 9.7% compared to pure lead samples of equivalent thickness. Based on FIG. 3, having a stacked layers left unbonded (i.e., dry stacked together), did not seem to produce a noticeable effect on the thickness-dependence trend.

It is noted that the density of the tested samples was about 12% that of the lead reference, leading to the shielding efficacy for a given mass to underperform a similar mass of lead. This is in part due to the mass fractions of non-Bismuth elements that do not contribute effectively to the shielding efficacy of the samples. Notably, the aluminum foil used in the CNT growth substrate could potentially be reduced or eliminated. This example only tested photon radiation with an energy range of approximately 1 MeV. The presence of LDPE was designed to increase shielding of protons, neutrons, and alpha particles, so presumably the overall effectiveness of the samples tested would be expected to be useful for lunar missions that experience a variety of radiation sources.

These multilayer samples also exhibited additional multifunctional properties. Notably, they are more ductile than either bulk LDPE or bulk metals, due to the anisotropic structure properties of the CNT array and laminate composite. Whereas bulk LDPE is brittle, and bulk aluminum is rigid, these samples could be easily bent and deformed without cracking. This is valuable for fabricating shielding materials into lightweight and complex structural components.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific instances of the invention described herein. Such equivalents are intended to be encompassed by the following claims.

1. A single-layered carbon nanostructure-based composite comprising:
a vertically aligned carbon nanostructure array comprising a plurality of carbon nanostructures on a substrate or support;
optionally a high shielding efficiency material coating on the plurality of carbon nanostructures of the vertically aligned carbon nanostructure array; and
a low-Z material coating the plurality of carbon nanostructures of the vertically aligned carbon nanostructure array.

2. The single-layered carbon nanostructure-based composite of claim 1, wherein the high shielding efficiency material coating is present on the plurality of carbon nanostructures of the vertically aligned carbon nanostructure array; and
the low-Z material encapsulates the high shielding efficiency material coated on the vertically aligned carbon nanostructure array.

3-6. (canceled)

7. The single-layered composite of claim 1, wherein the high shielding efficiency material is present and is a high-Z material.

8. The single-layered composite of claim 1, wherein the high shielding efficiency material is present and is a low-Z material.

9. The single-layered composite of claim 1, wherein the high shielding efficiency material coating is a conformal coating present on all or substantially all of the sidewalls and tips of the plurality of carbon nanostructures.

10-16. (canceled)

17. A multi-tiered carbon nanostructure-based composite comprising:
at least two vertically aligned carbon nanostructure arrays each comprising a plurality of carbon nanostructures on a substrate or support;
optionally a high shielding efficiency material coating on the plurality of carbon nanostructures of each of the at least two vertically aligned carbon nanostructure arrays; and
a low-Z material coating the plurality of carbon nanostructures of the vertically aligned carbon nanostructure array;
wherein the at least two vertically aligned carbon nanostructure arrays having the optional high shielding efficiency material coating and the low-Z material coating thereon are stacked to form the multi-tiered carbon nanostructure-based composite comprising at least two tiers.

18. The multi-tiered carbon nanostructure-based composite of claim 17,
wherein the high shielding efficiency material coating is present on the plurality of carbon nanostructures of each of the vertically aligned carbon nanostructure arrays; and
the low-Z material encapsulates the high shielding efficiency material coated on each of the vertically aligned carbon nanostructure arrays.

19-23. (canceled)

24. The multi-tiered composite of claim 17, wherein the high shielding efficiency material is present and is a high-Z material.

25. The multi-tiered composite of claim 17, wherein the high shielding efficiency material is present and is a low-Z material.

26. The multi-tiered composite of claim 17, wherein the high shielding efficiency material coating on the plurality of carbon nanostructures of each of the at least two vertically aligned carbon nanostructure arrays is a conformal coating present on all or substantially all of the sidewalls and tips of the plurality of carbon nanostructures.

27. The multi-tiered composite of claim 24, wherein the high-Z material coating on the plurality of carbon nanostructures of each of the at least two vertically aligned carbon nanostructure arrays is independently selected from the group consisting of aluminum, bismuth, cobalt, chromium, zinc, gallium, tantalum, platinum, gold, nickel, iron, tin, lead, silver, tungsten, titanium, indium, copper, antimony, zirconium, titanium, lithium, palladium, alloys thereof, metal oxides thereof, and metal hydrides thereof, and combinations thereof.

28. The multi-tiered composite of claim 17, wherein the high shielding efficiency material coating on the plurality of carbon nanostructures of each of the at least two vertically aligned carbon nanostructure arrays independently has a thickness ranging from about 1 to 10,000 nm.

29. The multi-tiered composite of claim 17, wherein the low-Z material is a polymer selected from the group consisting of non-conjugated polymers, conjugated polymers, or aromatic polymers, silicones, polyethylene, polyimides, polyamides, paraffins, polypropylene, and epoxies.

30. The multi-tiered composite of claim 17, wherein the composite is a planar laminate.

31. The multi-tiered composite of claim 18, wherein the low-Z material encapsulating the high shielding efficiency material coated plurality of carbon nanostructures of each of the vertically aligned carbon nanostructure arrays has a thickness ranging from about 1 to 1000 nm.

32-34. (canceled)

35. A method of making a multi-tiered carbon nanostructure-based composite comprising the steps of:
(1′″) forming or providing at least two vertically aligned carbon nanostructure arrays each on a substrate or support;
(2′″) optionally depositing or forming at least one high shielding efficiency material coating on each of the carbon nanostructures of the at least two arrays of step (1′″);
(3′″) forming a low-Z material coating on each of the at least two arrays to provide at least two single-layer carbon nanostructure-based composites;
(4′″) applying an adhesive coating layer onto each of the at least two single-layered carbon nanostructure-based composites; and
(5′″) stacking the at least two single-layer carbon nanostructure-based composites of step (4′″) to provide a multi-tiered carbon nanostructure-based composite.

36. The method of claim 35, wherein the at least one high shielding efficiency material coating is present and forms a conformal coating present on all or substantially all of the sidewalls and tips of the plurality of carbon nanostructures present.

37. The method of claim 35, wherein the high shielding efficiency material is present and is a high-Z material.

38. The method of claim 35, wherein the high shielding efficiency material is present and is a low-Z material.

39-48. (canceled)
